(19) United States
(12) Patent Application Publication
(10) Pub. No.: US 2024/0087520 A1
(43) Pub. Date: Mar. 14, 2024

(54) PIXEL CIRCUIT AND DISPLAY DEVICE

(71) Applicant: Sharp Kabushiki Kaisha, Sakai City, Osaka (JP)

(72) Inventors: Kuniaki OKADA, Sakai City (JP); Ryo YONEBAYASHI, Sakai City (JP)

(21) Appl. No.: 18/274,731

(22) PCT Filed: Feb. 1, 2021
(86) PCT No.: PCT/JP2021/003545

§ 371 Date: Jul. 28, 2023

(51) Int. Cl. G09G 3/3233

(52) U.S. Cl. CPC G09G 3/3233; G09G 2300/0819; G09G 2300/0842; G09G 2300/0861; G09G 2310/0262; G09G 2310/08; G09G 2320/0238; G09G 2320/045

(57) ABSTRACT

The present application discloses a display device capable of preventing a black display defect with a pixel circuit used therein in which P-type and N-type transistors are mixed. Provided is a pixel circuit including an organic EL element, a holding capacitor, a P-type drive transistor, a P-type writing control transistor, an N-type threshold compensation transistor, and the like, wherein during a data writing period, the voltage of a data signal line is written to the holding capacitor via the writing control transistor in ON state and the drive transistor brought into a diode-connected state by the threshold compensation transistor in ON state. A capacitance is provided between a first scanning signal line connected to a gate terminal of the writing control transistor and a gate terminal of the drive transistor. Consequently, when the P-type writing control transistor is turned off at the end of a data write period, a gate voltage Vg of the drive transistor increases, and this increase compensates for a decrease in the gate voltage Vg occurring when the N-type threshold compensation transistor is thereafter turned off.

### TECHNICAL FIELD

The present disclosure relates to a current-driven display device having a display element driven by current such as an organic EL (Electro Luminescence) element, and more particularly to a pixel circuit used in the display device.

### BACKGROUND ART

In recent years, an organic EL display device having a pixel circuit including an organic EL element (also called an organic light-emitting diode (OLED)) has been put to practical use. A pixel circuit in an organic EL display device includes a drive transistor, a write control transistor, a holding capacitor, etc., in addition to the organic EL element. A thin film transistor is used as the drive transistor and the write control transistor, and a holding capacitor is connected to a gate terminal serving as a control terminal of the drive transistor. A voltage corresponding to a video signal representing an image to be displayed (more specifically, a voltage representing a gradation value of a pixel to be formed by the pixel circuit) is applied as a data voltage. An organic EL element is a self-luminous display element that emits light with luminance corresponding to a current flowing through the organic EL element. The drive transistor is provided in series with the organic EL element and controls the current flowing through the organic EL element in accordance with a voltage held in the holding capacitor.

Variations and shifts occur in the characteristics of organic EL elements and drive transistors. Therefore, it is necessary to compensate for the variations and shifts in the characteristics of these elements in order to display high quality images in an organic EL display device. For organic EL displays, there are two known methods of compensating for the characteristics of the elements: one is to compensate for the characteristics of the elements inside the pixel circuit and the other is to compensate for the characteristics outside the pixel circuit. As a pixel circuit corresponding to the former method, a pixel circuit is known in which the voltage at the gate terminal of the drive transistor, i.e., the voltage held in the holding capacitor, is initialized and then the holding capacitor is charged with the data voltage via the drive transistor in diode connection state. In such a pixel circuit, variations and shifts in the threshold voltage of the drive transistor are compensated for internally (such compensation of variations and shifts in the threshold voltage is hereinafter referred to as “threshold compensation,” and the method in which threshold compensation is performed within the pixel circuit is called the “internal compensation method”).

A pixel circuit using a P-channel thin film transistor whose channel layer is formed of low temperature polysilicon (LTPS) is known as a pixel circuit of an organic EL display device that employs an internal compensation method. Since low-temperature polysilicon has high mobility, using a thin-film transistor whose channel layer is formed of low-temperature polysilicon (hereinafter referred to as “LTPS-TFT”) as a drive transistor improves the drive capability for the organic EL element in the pixel circuit, and when used as a switching element, the on-resistance is low.

In recent years, a thin film transistor (hereinafter referred to as “oxide TFT”) whose channel layer is formed of oxide semiconductor has attracted attention. Since the oxide TFT has a small off-leak current, it is suitable as a switching element in a pixel circuit or the like. Note that as the oxide TFT, a thin film transistor (hereinafter referred to as “IGZO-TFT”) containing indium gallium zinc oxide (InGaZnO) is typically used.

Furthermore, in order to implement a pixel circuit that combines the features of the LTPS-TFT, which can increase the drive capability of the drive transistor and reduce the on-resistance of the switching element, and the features of the oxide TFT, which can reduce the off-leakage current of the switching element, a pixel circuit in which P-channel type (hereinafter also referred to as “P-type”) LTPS-TFTs and N-channel type (hereinafter also referred to as “N-type”) oxide TFTs are mixed is also known (see, for example, Japanese Unexamined Patent Application Publication No. 2018-5237).

### PRIOR ART DOCUMENTS

### Patent Documents

Patent Document 1: Japanese Application Publication No. 2018-5237

### SUMMARY OF THE INVENTION

### Problems to be Solved by the Invention

The present inventors have confirmed that the following problem may occur: when black is to be displayed in a pixel circuit in which P-type transistors and N-type transistors are mixed (hereinafter referred to as “hybrid-type pixel circuit”) such as the pixel circuit in which LTPS-TFTs and oxide TFTs are mixed as described above, the luminance of the pixel circuit cannot be reduced to a sufficiently low value (the problem is hereinafter referred to as “black display defect”).

Therefore, it is desired to prevent the above-described black display defects from occurring in display devices that use hybrid-type pixel circuits with a mixture of P-type and N-type transistors.

### Solution to Problem

Several embodiments of the present invention provide a pixel circuit provided in a display device with a display portion including a plurality of data signal lines, a plurality of first scanning signal lines, and a plurality of second scanning signal lines, the pixel circuit corresponding to one of the data signal lines, one of the first scanning signal lines, and one of the second scanning signal lines, the pixel circuit including:
a current-driven display element;
a drive transistor having a control terminal, a first conduction terminal, and a second conduction terminal, and connected in series with the display element;
a holding capacitor whose first electrode is connected to the control terminal of the drive transistor so as to hold a voltage of the control terminal of the drive transistor;
a write control transistor as a switching element having a control terminal connected to a corresponding one of the first scanning signal lines, a first conduction terminal connected to a corresponding one of the data signal lines, a second conduction terminal connected to the first conduction terminal of the drive transistor; and
a threshold compensation transistor as a switching element having a control terminal connected to a corresponding one of the second scanning signal lines, a first conduction terminal connected to the second conduction terminal of the drive transistor, a second conduction terminal connected to the control terminal of the drive transistor, wherein,
the write control transistor and the threshold compensation transistor have different conductivity types from each other, and
there is formed a capacitance between the corresponding one of the first scanning signal lines and the control terminal of the drive transistor.

Several other embodiments of the present invention provide a display device with a display portion including a plurality of data signal lines, a plurality of first scanning signal lines, and a plurality of second scanning signal lines, the display device including:
a plurality of the pixel circuits according to the above several embodiments, each of the pixel circuits corresponding to one of the data signal lines, one of the first scanning signal lines, and one of the second scanning signal lines;
a data signal line drive circuit configured to drive the data signal lines; and
a scanning signal line drive circuit configured to selectively drive the first scanning signal lines and selectively drive the second scanning signal lines.

### Effect of the Invention

According to the above several embodiments of the present invention, in the display device with a display portion including a plurality of data signal lines, a plurality of first scanning signal lines, and a plurality of second scanning signal lines, there is provided a pixel circuit so as to correspond to one of the data signal lines, one of the first scanning signal lines, and one of the second scanning signal lines. In the pixel circuit, when the corresponding first scanning signal line and the corresponding second scanning signal line are in the selected state, the voltage of the corresponding data signal lines is written to the holding capacitor via the writing control transistor in ON state and the drive transistor brought into a diode-connected state by the threshold compensation transistor in ON state. After the end of the data voltage write operation, when the corresponding second scanning signal line is deselected and thereby the threshold compensating transistor changes from ON state to OFF state, a change in the voltage of the corresponding second scanning signal line affects the control voltage, which is the voltage of the control terminal of the drive transistor (which corresponds to the voltage written to the holding capacitor) through the parasitic capacitance of the threshold compensation transistor, causing the control voltage to change. Further, when the corresponding first scanning signal line is deselected and thereby the write control transistor changes from ON state to OFF state, a change in the voltage of the corresponding first scanning signal line affects the voltage (control voltage) of the control terminal of the drive transistor via the capacitance between the corresponding first scanning signal line and the control terminal of the drive transistor, causing the control voltage to change. Since the conductivity type of the write control transistor and the conductivity type of the threshold compensation transistor are different from each other, the voltage of the corresponding first scanning signal line at this time changes in the direction opposite to the voltage change of the corresponding second scanning signal line. Therefore, the control voltage change caused by the voltage change of the corresponding second scanning signal line can be compensated for (cancelled or reduced) by the control voltage change caused by the voltage change of the corresponding first scanning signal line based on the above capacitance. As a result, it is possible to prevent the problem that the luminance of the display element cannot be suppressed to a sufficiently low value when black is to be displayed in a hybrid pixel circuit in which P-type and N-type transistors are mixed, that is, black display defects can be prevented.

### BRIEF DESCRIPTION OF THE DRAWINGS

FIG. 1 is a block diagram showing the overall configuration of a display device according to a first embodiment.

FIG. 2 is a timing chart for describing the schematic operation of the display device according to the first embodiment.

FIG. 3 is a circuit diagram showing the configuration of a pixel circuit in a display device as a comparative example for the first embodiment.

FIG. 4 is a signal waveform diagram for describing the operation of the pixel circuit in the comparative example.

FIG. 5 is a circuit diagram showing the configuration of a pixel circuit in the first embodiment.

FIG. 6 is a signal waveform diagram for describing the operation of the pixel circuit in the first embodiment.

FIG. 7 is a diagram showing the stacking order of semiconductors and conductors used to form a pixel circuit in the first embodiment.

FIG. 8 is a diagram for describing the features of a layout pattern of the pixel circuit in the first embodiment.

FIG. 9 is a diagram for describing a layout pattern as a comparative example for the layout pattern of the pixel circuit shown in FIG. 8.

FIG. 10 is a circuit diagram showing the configuration of a pixel circuit in a display device according to a second embodiment.

FIG. 11 is a signal waveform diagram for describing the operation of the pixel circuit in the second embodiment.

### MODES FOR CARRYING OUT THE INVENTION

Embodiments will be described below with reference to the accompanying drawings. In each transistor referred to below, a gate terminal corresponds to a control terminal, one of a drain terminal and a source terminal corresponds to a first conduction terminal, and the other corresponds to a second conduction terminal. Further, although the transistors in the following embodiments are, for example, thin film transistors, the present invention is not limited to this. Furthermore, unless otherwise specified, the term “connection” herein refers to “electrical connection”, the meaning of which encompasses not only direct connection but also indirect connection through another or other elements, without departing from the gist of the present invention.

### 1. First Embodiment

### 1.1 Overall Configuration

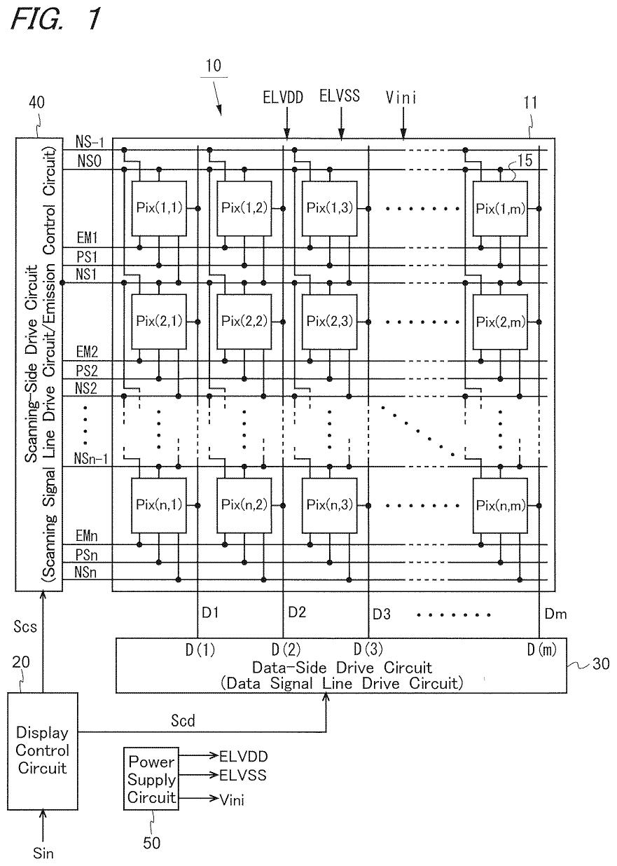

FIG. 1 is a block diagram showing the overall configuration of a display device 10 according to a first embodiment. This display device 10 is an organic EL display device that performs internal compensation. That is, in the display device 10, each pixel circuit has a function of compensating for variations and shifts in threshold voltage of a drive transistor therein.

As shown in FIG. 1, the display device 10 includes a display portion 11, a display control circuit 20, a data-side drive circuit 30, a scanning-side drive circuit 40, and a power supply circuit 50. The data-side drive circuit 30 functions as a data signal line drive circuit (also called “data driver”). The scanning-side drive circuit 40 functions as a scanning signal line drive circuit (also called a “gate driver”) and an emission control circuit (also called an “emission driver”). In the configuration shown in FIG. 1, these two scanning-side circuits are implemented as one scanning-side drive circuit 40, but in other configurations, these two circuits may be suitably separated or may be disposed separately on different sides of the display portion 11. Moreover, the data-side drive circuit and the scanning-side drive circuit, at least in part, may be integrally formed with the display portion 11. These can also be applied to other embodiments and modifications to be described later. The power supply circuit 50 generates a high-level power supply voltage ELVDD, a low-level power supply voltage ELVSS, and an initialization voltage Vini, all of which are to be supplied to the display portion 11, as will be described later. The power supply circuit 50 also generates a power supply voltage (not shown), which is to be supplied to the display control circuit 20, the data-side drive circuit 30, and the scanning-side drive circuit 40.

The display portion 11 has provided therein m (where m is an integer of 2 or more) data signal lines D1, D2, . . . , Dm, n first scanning signal lines PS1, PS2, . . . , PSn, and n+2 (where n is an integer of 2 or more) second scanning signal lines NS−1, NS0, NS1, . . . , NSn, and the first and second scanning signal lines intersect the data signal lines. Moreover, there are n emission control lines (emission lines) EM1 to EMn respectively provided along the n first scanning signal lines PS1 to PSn. Further, the display portion 11 is provided with m×n pixel circuits 15 arranged in a matrix along the m data signal lines D1 to Dm and the n first scanning signal lines PS1 to PSn. Each pixel circuit 15 corresponds to one of the m data signal lines D1 to Dm and one of the n first scanning signal lines PS1 to PSn (to distinguish the pixel circuits 15, the pixel circuit that corresponds to the ith first scanning signal line PSi and the jth data signal line Dj will also be referred to below as the “ith-row, jth-column pixel circuit” and denoted by the symbol “Pix(i,j)”). Moreover, each pixel circuit 15 also corresponds to one of the n second scanning signal lines NS1 to NSn and one of the n emission control lines EM1 to EMn.

In the display portion 11, a power supply line (not shown) common to each of the pixel circuits 15 is arranged. That is, a first power supply line for supplying a high-level power supply voltage ELVDD for driving an organic EL element to be described later (hereinafter referred to as a “high-level power supply line” and indicated by the symbol “ELVDD” like the high-level power supply voltage), and a second power supply line for supplying a low-level power supply voltage ELVSS for driving the organic EL element (hereinafter referred to as a “low-level power supply line” and indicated by the symbol “ELVSS” like the low-level power supply voltage) are arranged. More specifically, the low-level power supply line ELVSS is a common cathode for the multiple pixel circuits 15. Further, the display portion 11 is also provided with an initialization voltage line (not shown) for supplying an initialization voltage Vini used for initialization of each pixel circuit 15 (indicated by the symbol “Vini” as well as the initialization voltage). The high-level power supply voltage ELVDD, the low-level power supply voltage ELVSS, and the initialization voltage Vini are supplied from the power supply circuit 50.

The display control circuit 20 receives an input signal Sin including image information representing an image to be displayed and timing control information for image display from the outside of the display device 10, generates a data-side control signal Scd and a scanning-side control signal Scs based on the input signal Sin, and outputs the data-side control signal Scd and the scanning-side control signal Scs to the data-side drive circuit 30 and the scanning-side drive circuit 40, respectively.

The data-side drive circuit 30 drives the data signal lines D1 to Dm based on the data-side control signal Scd from the display control circuit 20. That is, the data-side drive circuit 30 generates m data signals D(1) to D(m) representing images to be displayed based on the data-side control signal Scd, and applies them to the data signal lines D1 to Dm, respectively.

Based on the scanning-side control signal Scs from the display control circuit 20, the scanning-side drive circuit 40 functions as a signal line drive circuit configured to drive the n first scanning signal lines PS1 to PSn and the n+2 second scanning signal lines NS−1 to NSn, and also functions as an emission control circuit configured to drive the n emission control lines EM1 to EMn.

More specifically, during each frame period, the scanning-side drive circuit 40 sequentially selects the n first scanning signal lines PS1 to PSn each for a predetermined period corresponding to one horizontal period and sequentially selects the n+2 second scanning signal lines NS−1 to NSn each for a predetermined period corresponding to one horizontal period, based on the scanning-side control signal Scs, applies an active signal to the selected first scanning signal line PSk (k is an integer of 1≤k≤n), applies an active signal to the selected the second scanning signal line NSs (s is an integer of −1≤s≤n), applies an inactive signal to the

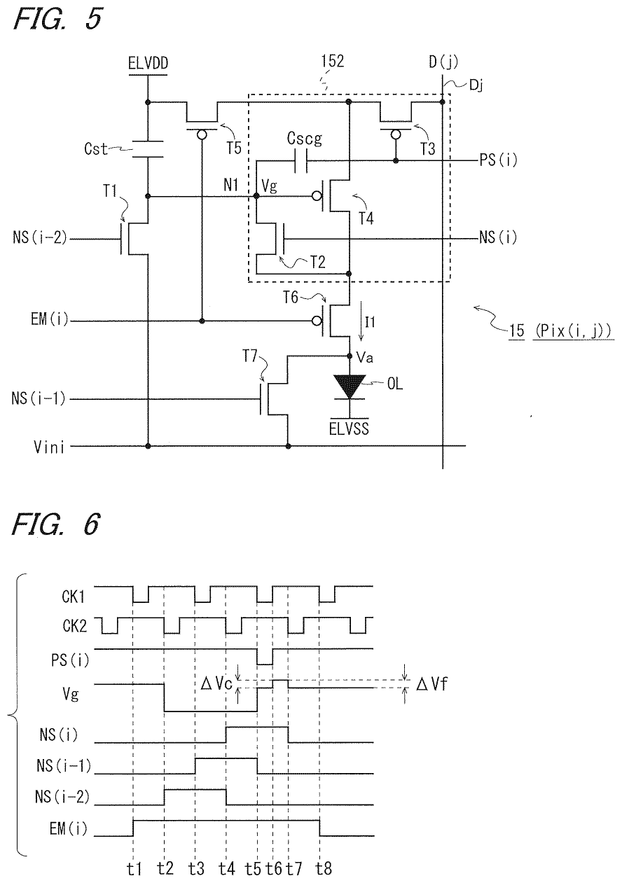

to the unselected first scanning signal lines, and an inactive signal to the unselected second scanning signal lines. Thus, m pixel circuits Pix(k, l) to Pix(k, m) corresponding to the selected first scanning signal line Gk (1≤k≤n) are selected collectively. As a result, the voltages of the m data signals D(1) to D(m) (hereinafter, these voltages may be simply referred to as “data voltages” without distinction) applied from the data-side drive circuit 30 to the data signal lines D1 to Dm in a selection period for the first scanning signal line PSk (hereinafter referred to as “kth scanning selection period”) are written as pixel data to the pixel circuits Pix(k, l) to Pix(k, m), respectively. As shown in FIG. 5 below, in the present embodiment, the first scanning signal line PSi1 is connected to the gate terminal of the P-type transistor in the pixel circuit 15 (i1=1 to n) and the second scanning signal line NSi2 is connected to the gate terminal of the N-type transistor in the pixel circuit 15 (i2=−1 to n). Therefore, a high-level voltage is applied to the selected first scanning signal line PSi1 as an active signal, and a low level voltage is applied to the selected second scanning signal line NSi2 as an active signal.

Furthermore, during each frame period, the scanning-side drive circuit 40 drives the emission control lines EM1 to EMn such that the emission control lines EM1 to EMn are selectively deactivated in conjunction with the driving of the first and second scanning signal lines PS1 to PSn and NS−1 to NSn. More specifically, the scanning-side drive circuit 40 functions as the emission control circuit in accordance with the scanning-side control signal Scs to apply an emission control signal that specifies non-emission (a high-level voltage) to the ith emission control line EMi (where i=1 to n) during a predetermined period of time including the ith horizontal period and an emission control signal that specifies emission (a low-level voltage) during other periods (details will be described later). While the voltage of the emission control line EMi is at low level (active), the organic EL elements in the pixel circuits Pix(i,l) to Pix(i,m) corresponding to the ith first scanning signal line PSi (referred to below as the “ith-row pixel circuits”) emit light with respective luminances that correspond to the data voltages written in the ith-row pixel circuits Pix(i,l) to Pix(i,m).

### 1.2 Operation Outline

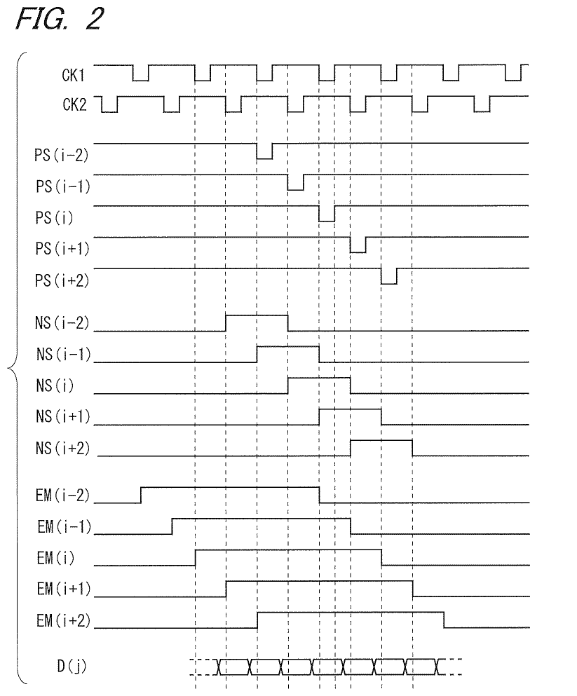

FIG. 2 is a timing chart for describing the operation outline of the display device 10 according to the present embodiment. The scanning control signal Scs provided to the scanning-side drive circuit 40 by the display control circuit 20 includes a two-phase clock signal consisting of first and second gate clock signals CK1 and CK2. The scanning-side drive circuit 40 generates first scanning signals PS(1) to PS(n) and second scanning signals NS(−1), NS(0), NS(1), . . . , NS(n) as shown in FIG. 2 in accordance with the two-phase clock signal, and applies the first scanning signals PS(1) to PS(n) to the first scanning signal lines PS1 to PSn, respectively, and the second scanning signals NS(−1) to NS(n) to the second scanning signal lines NS−1 to NSn, respectively. Moreover, in accordance with the two-phase clock signal (i.e., the first and second gate clock signals CK1 and CK2), the scanning-side drive circuit 40 generates emission control signals EM(1) to EM(n) as shown in FIG. 2, and applies the emission control signals EM(1) to EM(n) to the emission control lines EM1 to EMn, respectively. On the other hand, the data-side drive circuit 30 generates data signals D(1) to D(m), which change in relation to the first scanning signals PS(1) to PS(n), as shown in FIG. 2, in accordance with the data control signal Scd from the display control circuit 20, and applies the data signals D(1) to D(m) to the data signal lines D1 to Dm, respectively. In this manner, the first scanning signal lines PS1 to PSn, the second scanning signal lines NS−1 to NSn, the emission control lines EM1 to EMn, and the data signal lines D1 to Dm in the display portion 11 are driven, so that in each pixel circuit Pix(i,j), initialization and data voltage writing are performed when the corresponding emission control line EMi is inactive (when the emission control signal EM(i) is at high level), and the organic EL element emits light with luminance corresponding to the data voltage when the corresponding emission control line EMi is active (when the emission control signal EM(i) is at low level).

In the present embodiment, the first scanning signal lines PS1 to PSn, the second scanning signal lines NS−1 to NSn, the emission control lines EM1 to EMn, and the data signal lines D1 to Dm are driven as described above, in accordance with the signals shown in FIG. 2, so as to rewrite in each frame period image data for one frame consisting of pixel data (data voltages) respectively held in the n×m pixel circuits Pix(1,1) to Pix(n,m) in the display portion 11.

As will be described later, in the present embodiment, in each frame period, data write operation is performed for each pixel circuit Pix(i, j) when the corresponding first and second scanning signal lines PSi, NSi are in the selected state. When the second scanning signal line NSi−2 two lines prior to the second scanning signal line NSi is in the selected state, an initialization operation of a holding capacitor Cst (this corresponds to an initialization operation of voltage of a gate terminal of a drive transistor T4 and is hereinafter also referred to as “control voltage initialization operation”) is performed. When the second scanning signal line NSi−1 immediately preceding the second scanning signal line NSi is in the selected state, an initialization operation of voltage of an anode electrode in the organic EL element OL (hereinafter also referred to as an “anode voltage initializing operation”) is performed. The emission control line EMi is driven such that each pixel circuit Pix (i, j) is in a non-emission state when the data write operation, the control voltage initialization operation, and the anode voltage initialization operation are performed therein (i=1 to n) (see FIG. 6 below). In the pixel circuit Pix(i,j) of the present embodiment, P-type transistors are used as first and second emission control transistors T5 and T6 (see FIG. 5 described later). Accordingly, each emission control line EMi becomes activated when a low level (L-level) voltage is applied, and deactivated when a high-level (H-level) voltage is applied.

The operation outline of the display device 10 according to the present embodiment is as described above. Alternatively, the display device 10 may be configured to have two operating modes: a normal drive mode and a pause drive mode. In this case, in the normal drive mode, the image data (data voltage in each pixel circuit) of the display portion 11 is rewritten in each frame period as above. In the pause drive mode, a drive period, which consists only of a refresh frame period for rewriting the image data, alternates with a pause period, which consists of a plurality of non-refresh frame periods for stopping the rewriting of the image data in the display portion 11.

### 1.3 Configuration and Operation of Pixel Circuit

In the following, first, the configuration and operation of a pixel circuit (hereinafter also referred to as “comparative pixel circuit”) in a display device as a comparative example of the present embodiment will be described, and then, the configuration and operation of the pixel circuit 15 in the present embodiment will be described in comparison with the configuration and operation of the pixel circuit in the comparative example. Note that since the configuration of the display device as the comparative example is the same as that of the display device according to the present embodiment except for the pixel circuit, the same or corresponding parts are denoted by the same reference numerals and the description thereof is omitted.

### 1.3.1 Configuration and Operation of Pixel Circuit in Comparative Example

As described above, the inventors of the present application have confirmed that in the hybrid pixel circuit, in which a P-type transistor and an N-type transistor are mixed, a problem (black display defect) may occur in which the luminance cannot be suppressed to a sufficiently low value when black is to be displayed. The following describes the configuration and operation of the pixel circuit in the comparative example with reference to the mechanism causing the black display defect.

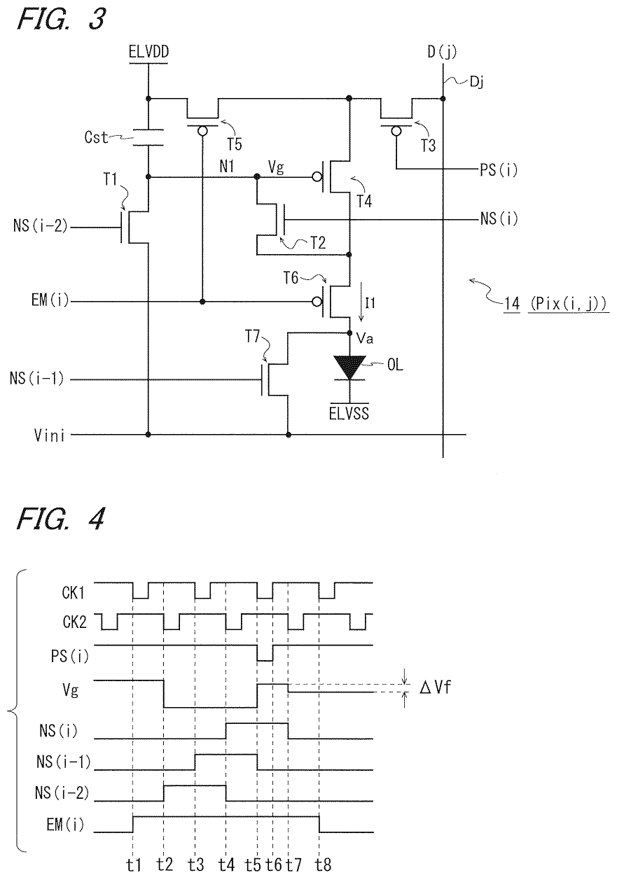

FIG. 3 is a circuit diagram showing the configuration of the pixel circuit 14 in the comparative example, and more specifically, the pixel circuit 14 corresponding to the ith first scanning signal line PSi and the jth data signal line Dj, i.e., the pixel circuit Pix(i, j) in the ith row and jth column (1≤i≤n, 1≤j≤m). The pixel circuit 14 shown in FIG. 3 has basically the same configuration as the pixel circuit disclosed in Japanese Unexamined Patent Publication No. 2018-5237 (see FIG. 4, etc. of the same publication). That is, the pixel circuit 14 has one organic EL element OL as a display element and seven transistors T1 to T7 (these are hereinafter referred to as “first initialization transistor T1”, “threshold compensation transistor T2”, “write control transistor T3”, “drive transistor T4”, “first emission control transistor T5”, “second emission control transistor T6”, and “second initialization transistor T7”) and one holding capacitor Cst. Transistors T1, T2, and T7 are N-type transistors (more specifically, N-type IGZO-TFTs). Transistors T3 to T6 are P-type transistors (more specifically, P-type LTPS-TFT). The holding capacitor Cst is a capacitive element having two electrodes comprising a first electrode and a second electrode. In the pixel circuit 14, the transistors T1 to T3 and T5 to T7 other than the drive transistor T4 function as switching elements.

The pixel circuit Pix(i,j) is connected to the first scanning signal line PSi that corresponds to the pixel circuit Pix(i,j) (also referred to below as the “corresponding first scanning signal line” in the description focusing on the pixel circuit), the second scanning signal line NSi that corresponds to the pixel circuit Pix(i,j) (also referred to below as the “corresponding second scanning signal line” in the description focusing on the pixel circuit), the second scanning signal line that is two lines prior to the corresponding second scanning signal line NSi (the scanning signal line preceding by two lines in the order of scanning the second scanning signal lines NS−1 to NSn), i.e., the (i−2)th second scanning signal line NSi−2 (also referred to below as the “preceding second scanning signal line” in the description focusing on the pixel circuit), the second scanning signal line immediately preceding the corresponding second scanning signal line NSi, i.e., the (i−1)th second scanning signal line NSi−1 (also referred to below as the “immediately preceding second scanning signal line” in the description focusing on the pixel circuit), the emission control line EMi that corresponds to the pixel circuit Pix(i,j) (also referred to below as the “corresponding emission control line” in the description focusing on the pixel circuit), the data signal line Dj that corresponds to the pixel circuit Pix(i,j) (also referred to below as the “corresponding data signal line” in the description focusing on the pixel circuit), the initialization voltage line Vini, the high-level power supply line ELVDD, and the low-level power supply line ELVSS.

The first initialization transistor T1 has a gate terminal connected to the preceding second scanning signal line NSi−2, and a drain terminal connected to the first electrode of the holding capacitor Cst, a gate terminal of the drive transistor T4, and a source terminal of the threshold compensation transistor T2. The second initialization transistor T7 has a gate terminal connected to the immediately preceding second scanning signal line NSi−1, a source terminal connected to the initialization voltage line Vini, and a drain terminal connected to the anode electrode of the organic EL element OL.

The threshold compensation transistor T2 has a gate terminal connected to the corresponding second scanning signal line NSi, a drain terminal connected to a drain terminal of the drive transistor T4 and a source terminal of the second emission control transistor T6, and a source terminal connected to the gate terminal of the drive transistor T4.

The write control transistor T3 has a gate terminal connected to the corresponding first scanning signal line PSi, a source terminal connected to the corresponding data signal line Dj, and a drain terminal connected to a source terminal of the drive transistor T4 and the first emission control transistor T5.

The drive transistor T4 has the gate terminal connected to the first electrode of the holding capacitor Cst, the source terminal connected to the drain terminal of the write control transistor T3 and a drain terminal of the first emission control transistor, and the drain terminal connected to the source terminal of the second emission control transistor T6.

The first emission control transistor T5 has a gate terminal connected to the corresponding emission control line EMi, a source terminal connected to the high-level power supply line ELVDD, and the drain terminal connected to the source terminal of the drive transistor T4. The second emission control transistor T6 has a gate terminal connected to the corresponding emission control line EMi, the source terminal connected to the drain terminal of the drive transistor 14, and a drain terminal connected to the anode electrode of the organic EL element OL.

The holding capacitor Cst has the first electrode connected to the gate terminal of the drive transistor T4 and a second electrode connected to the high-level power supply line ELVDD. The organic EL element OL has the anode electrode connected to the drain terminal of the second emission control transistor T6, and a cathode electrode connected to the low-level power supply line ELVSS.

Next, the operation of the pixel circuit 14 shown in FIG. 3, that is, the pixel circuit Pix(i, j) in the ith row and jth column in the comparative example will be described with reference to FIG. 3 and FIG. 4. FIG. 4 is a signal waveform diagram for describing the operation of the pixel circuit Pix(i,j) during the non-emission period included in each frame period.

A emission control signal (hereinafter referred to as a “corresponding emission control signal”) EM(i) supplied to the pixel circuit Pix(i,j) of FIG. 3 via the corresponding emission control line EMi changes from L level to H level at time t1. Then, the P-type first and second emission control transistors T5 and T6 change from ON state to OFF state, and maintain OFF state while the emission control signal EM(i) is at H level. Therefore, during the period t1 to t8 when the emission control signal EM(i) is at H level, no current flows through the organic EL element OL and the pixel circuit Pix(i,j) is in the non-emission state.

During the period when the pixel circuit Pix(i, j) is in the non-emission state, i.e., the non-emission period t1 to t8, the second scanning signal (hereinafter also referred to as “preceding second scanning signal”) NS(i−2) supplied to the pixel circuit Pix (i, j) via the preceding second scanning signal line NSi−2 changes from L level to H level, thereby causing the N-type first initialization transistor T1 to change from OFF state to ON state and to maintain ON state while the second scanning signal NS(i−2) is at H level. During the period when the first initialization transistor T1 is in ON state (hereinafter referred to as the “initialization period”) from t2 to t4, the holding capacitor Cst is initialized and the voltage of node N1 including the gate terminal of drive transistor T4 and the first electrode of holding capacitor Cst becomes the initialization voltage Vini. In other words, the voltage of the gate terminal of drive transistor T4 (hereinafter referred to as “gate voltage”) Vg becomes the initialization voltage Vini.

At time t3 within the non-emission period t1 to t8 of the pixel circuit Pix(i,j) in FIG. 3, the preceding second scanning signal NS(i−2) changes to L level, and the second scanning signal NS(i) (hereinafter referred to as “corresponding second scanning signal”) supplied via the corresponding second scanning signal line NSi changes to H level. As a result, the N-type threshold compensation transistor T2 changes from OFF state to ON state and maintains ON state while the corresponding second scanning signal NS(i) is at H level, and the drive transistor T4 is diode connected.

During the period t4 to t7 when the threshold compensation transistor T2 is in ON state, the first scanning signal PS(i) (hereinafter also referred to as the “corresponding first scanning signal”) is supplied to the pixel circuit Pix(i,j) through the corresponding first scanning signal line PSi changes from H level to L level at time t5. As a result, the P-type write control transistor T3 changes from OFF state to ON state, and maintains ON state while the corresponding first scanning signal PS(i) is at L level. During the period t5 to t6 when the write control transistor T3 is in ON state (hereinafter referred to as a “data write period”), a data signal D(j) supplied to the pixel circuit Pix(i,j) via the corresponding data signal line Dj is provided as the data voltage Vdata to the holding capacitor Cst through the diode-connected drive transistor 14. As a result, the threshold-compensated data voltage is written and held in the holding capacitor Cst, and the gate voltage Vg of the drive transistor T4 is maintained at the voltage of the first electrode of the holding capacitor Cst. At this time, the gate voltage Vg has a value given by the following equation, where Vth (<0) is a threshold value of the drive transistor T4.

Vg=Vdata+Vth (1)

In this way, during the data write period t5 to t6, the data voltage is written while performing the internal compensation.

At time t7 after the data write period t5 to t6, the corresponding second scanning signal NS(i) changes from H level to L level, and the threshold compensation transistor T2 is turned off. The voltage change (change from H to L) of the corresponding second scanning signal NS(i) affects the voltage of the node N1, i.e., the gate voltage Vg via the parasitic capacitance Cgs between the gate and source of the threshold compensation transistor T2, the gate voltage Vg decreases by ΔVf from the value represented by the above equation (1). This voltage drop ΔVf (>0) is a pull-in voltage caused by the change of the N-type threshold compensation transistor T2 from ON state to OFF state.

After that, at time t8, the corresponding emission control signal EM(i) changes from H level to L level, thereby turning on the first and second emission control transistors T5 and T6, and the emission period starts. During the emission period, a current I1 corresponding to the voltage held in the holding capacitor Cst, i.e., the voltage (absolute value) |Vgs| between the gate and source of the drive transistor T4, flows from the high-level power supply line ELVDD to the low-level power supply line ELVSS by way of the first emission control transistor T5, the drive transistor T4, the second emission control transistor T6, and the organic EL element OL. As a result, the organic EL element OL emits light with luminance corresponding to the current I1.

As described above, the voltage of the node N1, i.e., the gate voltage Vg, drops by the pull-in voltage ΔVf when the threshold compensation transistor T2 changes from ON state to OFF state at time t7. Here, a specific voltage setting example for the pixel circuit is shown. The H level voltage is 8 V, the L level voltage is −8 V, the voltage range of the data signal line Di is 1 to 6 V, the white voltage is 1 V, and the black voltage is 6 V (in this case, for example, the high-level power supply voltage ELVDD is 5V, the low-level power supply voltage ELVSS is −5V, and the initialization voltage Vini is −5V). In such a voltage setting example, when the threshold compensation transistor T2 is turned off, its gate voltage Vg, i.e., the voltage of the corresponding second scanning signal NS(i) changes from 8V to −8V, and the pull-in voltage ΔVf caused by this voltage change is non-negligible compared to the voltage range of the data signal line Di (1 to 6V).

Since such a pull-in voltage ΔVf is generated when the threshold compensation transistor T2 turns off, the voltage |Vgs| between the gate and source of drive transistor 14 becomes larger by the pull-in voltage ΔVf than the voltage written to the holding capacitor Cst during the data write period t5 to t6 (“write voltage”). Thus, the above current I1 flowing through the drive transistor T4 and the organic EL element increases, and as a result the organic EL element emits light with luminance higher than that corresponding to the write voltage to the holding capacitor Cst. In other words, the organic EL element OL emits light with luminance higher than that corresponding to the data signal D(j) due to the decrease in the gate voltage Vg caused by the voltage change in the corresponding second scanning signal NS(i). Therefore, in order to make the luminance of the organic EL element OL be a lower value corresponding to black display when black is to be displayed, the voltage of the data signal D(j) indicating black may be increased. However, if the voltage of the data signal D(j) (black voltage) is made higher, the margin for the voltage range that can be output from the data-side drive circuit 30 to the data signal line Dj becomes smaller. This may cause a defect that the luminance of the organic EL element OL cannot be suppressed to a sufficiently low value when black is to be displayed, that is, a black display defect may occur.

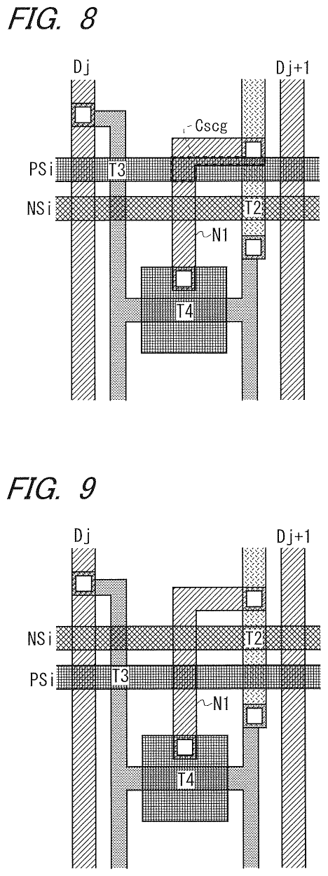

In addition to the corresponding second scanning signal NS(i), any signal that changes from H level to L level after the data write period t5 to t6 may cause a black display defect. For example, the emission control signal EM(i), which changes from H level to L level at time t8, may also be a cause of “black display defect”. However, even in the case that such a signal is used, if the capacitive coupling between the signal line transmitting the such a signal and the node N1 is negligible (the parasitic capacitance between the signal line and the node N1 is negligible), the such a signal is not a cause of black display defect. When a layout pattern as described below is adopted for the pixel circuit (see FIG. 8), the pattern of the corresponding light emission control line EMi can be placed in a position such that the capacitive coupling between the corresponding light emission control line EMi and the node N1 can be ignored. Therefore, for convenience, the following description assumes that the only signal that causes the black display defect is the corresponding second scanning signal NS(i).

### 1.3.2 Configuration and Operation of Pixel Circuit in First Embodiment

FIG. 5 is a circuit diagram showing the configuration of the pixel circuit 15 in the present embodiment, and more specifically, the pixel circuit 15 corresponding to the ith first scanning signal line PSi and the jth data signal line Dj, i.e., the pixel circuit Pix(i,j) in the ith row and the jth column (1≤i≤n, 1≤j≤m). The configuration of the pixel circuit 15 illustrated here is an example, and the configuration is not limited to this. Similarly to the pixel circuit 14 of the comparative example shown in FIG. 3, the pixel circuit 15 includes one organic EL element OL as a display element and seven transistors T1 to T7 (similarly to the comparative example, these are referred to as “first initialization transistor T1”, “threshold compensation transistor T2”, “write control transistor T3”, “drive transistor T4”, “first emission control transistor T5”, “second emission control transistor T6”, “second initialization transistor T7”) and one holding capacitor Cst. Transistors T1, T2 and T7 are N-type transistors. Transistors T3 to T6 are P-type transistors. The N-type transistors T1, T2, T7 are IGZO-TFTs, and the P-type transistors T3 to T6 are LIPS-TFTs, but are not limited to this. For example, oxide TFTs other than IGZO-TFTs may be used as the transistors T1, T2, and T7. The holding capacitor Cst is a capacitive element having two electrodes consisting of a first electrode and a second electrode. Also in the pixel circuit 15, the transistors T1 to T3 and T5 to T7 other than the drive transistor T4 function as switching elements.

The pixel circuit Pix(i, j) in FIG. 5 according to the present embodiment, as in the pixel circuit Pix(i, j) in the comparative example in FIG. 3, is connected to the second scanning signal line corresponding to the pixel circuit Pix(i, j) (the corresponding second scanning signal line) NSi, the second scanning signal line two lines prior to the corresponding second scanning signal line NSi, i.e., the (i−2)th second scanning signal line (preceding second scanning signal line) NSi−2, the second scanning signal line immediately preceding the corresponding second scanning signal line NSi, i.e., the (i−1)th second scanning signal line (immediately preceding second scanning signal line) NSi−1, the first scanning signal line corresponding to the pixel circuit Pix(i, j) (the corresponding first scanning signal line) PSi, a emission control line corresponding to the pixel circuit Pix(i, j) (the corresponding emission control line) EMi, a data signal line corresponding to the pixel circuit Pix(i, j) (the corresponding data signal line) Dj, the initialization voltage line Vini, the high-level power supply line ELVDD, and the low-level power supply line ELVSS. Note that the pixel circuit Pix(i, j) may be connected to the corresponding second scanning signal line NSi or the corresponding emission control line EMi instead of the immediately preceding second scanning signal line NSi−1. The pixel circuit Pix(i,j) may be connected to the immediately preceding second scanning signal line NSi−1 instead of the preceding second scanning signal line NSi−2.

The basic connection configuration of the pixel circuit Pix(i, j) in the present embodiment, that is, the connection relationship among the components T1 to T7, Cst, and OL in the pixel circuit Pix(i, j), and the connection relationship with the components T1 to T7, Cst, OL regarding the signal lines NSi, NSi−1, NSi−2, PSi, EMi, Dj, the power supply lines ELVDD, ELVSS, and the initialization voltage line Vini which are connected to the pixel circuits Pix(i, j), are as shown in FIG. 5. This basic connection configuration is the same as the connection configuration of the pixel circuit Pix(i, j) in the comparative example (see FIG. 3). However, the pixel circuit Pix(i,j) in the present embodiment differs from the pixel circuit Pix(i,j) in the comparative example in that a capacitance Cscg is formed between the node N1 including the gate terminal of the drive transistor T4 and the corresponding first scanning signal line PSi. The capacitance Cscg compensates for the change in gate voltage Vg using the voltage change in the corresponding first scanning signal PS(i) after the voltage (data voltage) of the corresponding data signal line Dj is written to the holding capacitor Cst (This capacitance Cscg is hereinafter referred to as “compensation capacitance Cscg”).

Next, the operation of the pixel circuit 15 shown in FIG. 5, i.e., the pixel circuit Pix(i,j) in the ith row and jth column in the present embodiment will be described with reference to FIGS. 5 and 6. FIG. 6 is a signal waveform diagram for describing the operation of the pixel circuit Pix(i,j) during the non-emission period included in each frame period.

As can be seen by comparing FIG. 6 with FIG. 4, the second scanning signals NS(i), NS(i−1), NS(i−2), the first scanning signal PS(i), the emission control signal EM(i), and the data signal D(j), which are supplied to drive the pixel circuit Pix(i,j) in the present embodiment, change in the same way as the second scanning signals NS(i), NS(i−1), NS(i−2), first scanning signal PS(i), emission control signal EM(i), and data signal D (j), which are supplied to drive the pixel circuit Pix(i,j) in the comparative example. As a result, the transistors T1 to T3 and T5 to T7 as switching elements included in the pixel circuit 15 in the present embodiment operate in the same manner as the transistors T1 to T3 and T5 to T7 as switching elements included in the pixel circuit 14 in the comparison example, so that the same initialization and data write operations are performed.

However, as described above, in the pixel circuit 15 in the present embodiment, the compensation capacitor Cscg is provided between the node N1 including the gate terminal of the drive transistor T4 and the corresponding first scanning signal line PSi. The change in the gate voltage Vg of the transistor T4 is different from the change in the gate voltage Vg in the pixel circuit 14 in the comparative example. The operation of the pixel circuit 15 will be described below, focusing on this difference. Note that a detailed description will be omitted for the parts of this operation that are the same as the operation of the pixel circuit 14 in the comparative example.

Also in the present embodiment, the gate voltage Vg of the drive transistor T4 becomes the initialization voltage Vini at time t2 through the initialization operation by the first initialization transistor T1 during the period t2 to t4, and is maintained at the initialization voltage Vini until time t5. Thereafter, the gate voltage Vg becomes the data voltage Vdata+Vth with threshold compensation through the data write operation by the write control transistor T3 during the period t5 to t6 (with compensation operation by the threshold compensation transistor T2) (see equation (1) already described). However, unlike the comparative example, in the present embodiment, when the write control transistor T3 turns off at time t6 by the corresponding first scanning signal PS(i) changing from L level to H level, the voltage change of the corresponding first scanning signal PS(i) affects the voltage of the node N1, i.e., the gate voltage Vg, via compensation capacitance Cscg, with the result that the gate voltage Vg is increased from Vdata+Vth. This increase in gate voltage Vg (hereinafter referred to as “compensation voltage”) ΔVc (>0) is determined by the voltage change of the corresponding first scanning signal PS(i) and the capacitance values of the holding capacitor Cst and the compensation capacitance Cscg, etc., and can be adjusted with the compensation capacitance Cscg.

At time t7 after the data write period t5 to t6, as in the comparative example, when the corresponding second scanning signal NS(i) changes from H level to L level and the threshold compensation transistor T2 turns off in the present embodiment, this voltage change in the corresponding second scanning signal NS(i) affects the gate voltage Vg of the drive transistor T4 via the parasitic capacitance of the threshold compensation transistor T2 Cgs, so that the gate voltage Vg decreases by the pull-in voltage ΔVf. However, as described above, the gate voltage rises by ΔVc at time t6 through the compensation capacitance Cscg. Therefore, after time t7, the gate voltage Vg becomes as follows:

Vg=Vdata+Vth+ΔVc−ΔVf (2)

Therefore, during the emission period after time t8, the current I1 corresponding to the voltage (absolute value) |Vgs| between the gate and source of drive transistor T4 based on the gate voltage Vg represented by the above equation (2) flows through the drive transistor T4 and the organic EL element OL, and the organic EL element OL emits light with luminance corresponding to the current I1.

As can be seen from the above equation (2), the voltage drop (pull-in voltage) ΔVf, which occurs when the corresponding second scanning signal NS(i) changes from H level to L level, can be compensated by the voltage increase ΔVc through the compensation capacitance Cscg for the gate voltage Vg of drive transistor T4.

### 1.4 Pixel Circuit Layout Pattern

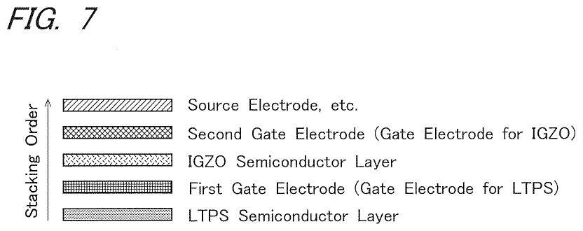

The layout pattern for implementing the pixel circuit 15 (FIG. 5) in the present embodiment (hereinafter referred to as “pixel circuit layout pattern”) will be described below with reference to FIGS. 7 and 8. FIG. 7 shows the stacking order of semiconductors and conductors used to form the pixel circuit in the present embodiment. FIG. 8 is a partial layout diagram showing a characteristic part of the layout pattern of the pixel circuit 15 in the present embodiment and shows a layout pattern of a circuit portion 152 surrounded by dotted lines in FIG. 5. Note that insulating layers are formed between the layers adjacent to each other shown in FIG. 7.

In FIGS. 7 and 8, a pattern hatched with dots indicates a wiring pattern formed of LIPS semiconductor in one layer, a pattern hatched with a regular lattice pattern indicates a wiring pattern of gate electrode for LIPS as a first gate electrode formed of metal material in another layer, and a pattern hatched with two kinds of micro lines in diagonal direction indicates a wiring pattern formed of IGZO semiconductor (indium gallium zinc oxide) in another layer, and a pattern hatched with diagonal lattice indicates a wiring pattern of gate electrode for IGZO as a second gate electrode formed of metal material in another layer, a pattern hatched with diagonal lines indicates a wiring pattern of source electrode, data signal lines, power supply voltage lines, etc. formed with metallic materials in another layer. A small square area without hatching in an overlapping area of wiring patterns of two layers different from each other indicates a contact hole, and the wiring patterns of those two layers are electrically connected by the contact hole. The above expression method for layout patterns shall also be adopted in FIG. 9 below.

As shown in FIG. 8, in the layout pattern of the pixel circuit 15 in the present embodiment, the wiring pattern of the first gate electrode (wiring pattern of the corresponding first scanning signal line PSi) extending in the row direction (left and right directions of the figure) and the wiring pattern of the second gate electrode (corresponding wiring pattern of the second scanning signal line NSi) are arranged adjacent to each other near the layout pattern of the drive transistor T4, and the wiring pattern of the first gate electrode (PSi) is farther from the drive transistor T4 than the wiring pattern of the second gate electrode (NSi). Based on this arrangement, the wiring pattern of the metal wiring connected to the first gate electrode (gate electrode for LIPS) that forms the gate terminal of the drive transistor T4, i.e., the wiring pattern that constitutes part of the node N1, partially overlaps with the pattern of the first gate electrode (PSi), which is farther from the layout pattern of the drive transistor T4. The compensation capacitance Cscg is formed by the metal wiring of the node 1 and the first gate electrode in this overlapped area. In FIG. 8, this overlapped area is surrounded by a thick dotted line, and the capacitance value of the compensation capacitance Cscg can be adjusted by the area of this overlapped area.

Next, the features of the layout pattern of the pixel circuit 15 in the present embodiment will be described with reference to FIGS. 8 and 9. FIG. 9 is a partial layout diagram showing a portion corresponding to the portion shown in FIG. 8 in a layout pattern as a comparative example for the layout pattern of the pixel circuit 15.

As already mentioned, in the layout pattern of the pixel circuit 15 shown in FIG. 8, in the vicinity of the layout pattern of the drive transistor T4, of the wiring pattern (PSi) of the first gate electrode and the wiring pattern (NSi) of the second gate electrode that are adjacent and extend in the row direction (left and right directions in the figure), the wiring pattern (PSi) of the first electrode is located farther from the drive transistor T4 than the wiring pattern (NSi) of the second gate electrode. As shown in FIG. 8, the metal wiring pattern that constitutes part of node N1 including the gate terminal of drive transistor T4 is arranged to partially overlap with the wiring pattern (PS(i)) of the first gate electrode that is farther from the layout pattern of drive transistor 14.

In contrast, in the layout pattern as the comparative example, as shown in FIG. 9, in the vicinity of the layout pattern of drive transistor T4, of the wiring pattern (PSi) of the first gate electrode and the wiring pattern (NSi) of the second gate electrode that are adjacent and extend in the row direction (left and right directions in the figure), the wiring pattern (PSi) of the first electrode is located closer to the drive transistor T4 than the wiring pattern (NSi) of the second gate electrode.

In the layout pattern shown in FIG. 8 for the pixel circuit 15 in the present embodiment, the write control transistor T3 is placed on the wiring pattern of the first gate electrode (PSi), so that the wiring pattern of the LIPS semiconductor layer as the source wiring that branches off from the wiring pattern of the data signal line Dj extending in the column direction to the write control transistor T3 does not intersect the wiring pattern (NSi) of the second gate electrode as the gate wiring of the threshold compensation transistor T2. In contrast, as shown in FIG. 9, in the layout pattern as the comparative example, the wiring pattern of the LIPS semiconductor layer as the source wiring of the write control transistor T3 intersects the wiring pattern (NSi) of the second gate electrode. Therefore, if the layout pattern of FIG. 8 is adopted to implement the pixel circuit 15, unlike the layout pattern of FIG. 9, there is no area where the wiring pattern of the LIPS semiconductor as the source wiring of the write control transistor T3 and the wiring pattern (NSi) of the second gate electrode overlap and the wiring capacitance of the data signal line Dj is reduced.

In the layout patterns of FIGS. 8 and 9, the threshold compensation transistor T2 is placed on the wiring pattern (NSi) of the second gate electrode, and therefore, unlike in the layout pattern of FIG. 9, in the layout pattern of FIG. 8, a contact hole for connecting (the source terminal of) the threshold compensation transistor T2 to the node N1 may be formed overlapping the wiring pattern (PSi) of the first gate electrode. Thus, the layout pattern in FIG. 8 requires a smaller area for layout of the threshold compensation transistor T2 than the layout pattern in FIG. 9.

### 1.5 Effects

According to the present embodiment as described above, in the hybrid pixel circuit 15 in which P-type transistors and N-type transistors are mixed by including both LIPS-TFTs and IGZO-TFTs as oxide TFTs, the compensation capacitor Cscg is formed between the node N1 including the gate terminal of the drive transistor 14 and the corresponding first scanning signal line PSi (FIG. 5). Hence, when the corresponding first scanning signal PS(i) changes from L level to H level and the write control transistor T3 is turned off, the gate voltage Vg of the drive transistor T4 is increased by a voltage ΔVc corresponding to the capacitance value of the compensation capacitor Cscg from the voltage Vdata+Vth written during the data write period t5 to t6. This voltage increase ΔVc can compensate for the voltage drop (pull-in voltage) ΔVf caused by the parasitic capacitance Cgs of the threshold compensation transistor T2 when the corresponding second scanning signal NS(i) changes from H level to L level after the data write period t5 to t6. Therefore, according to the pixel circuit 15 in the present embodiment, it is possible to prevent the defect of not reducing the luminance of the organic EL element OL to a sufficiently low value when black is to be displayed, i.e., a black display defect.

Furthermore, by adopting the layout pattern shown in FIG. 8 to implement the pixel circuit 15 (FIG. 5) in the present embodiment, the wiring capacitance of the data signal line is reduced as compared with the case where the layout pattern shown in FIG. 9 is adopted. This enables high-speed driving of the data signal line Dj. In addition, the layout pattern of FIG. 8 requires a smaller area for layout of the threshold compensation transistor T2 as compared with the layout pattern of FIG. 9, contributing to the reduction of the pixel circuit for higher resolution.

### 2. Second Embodiment

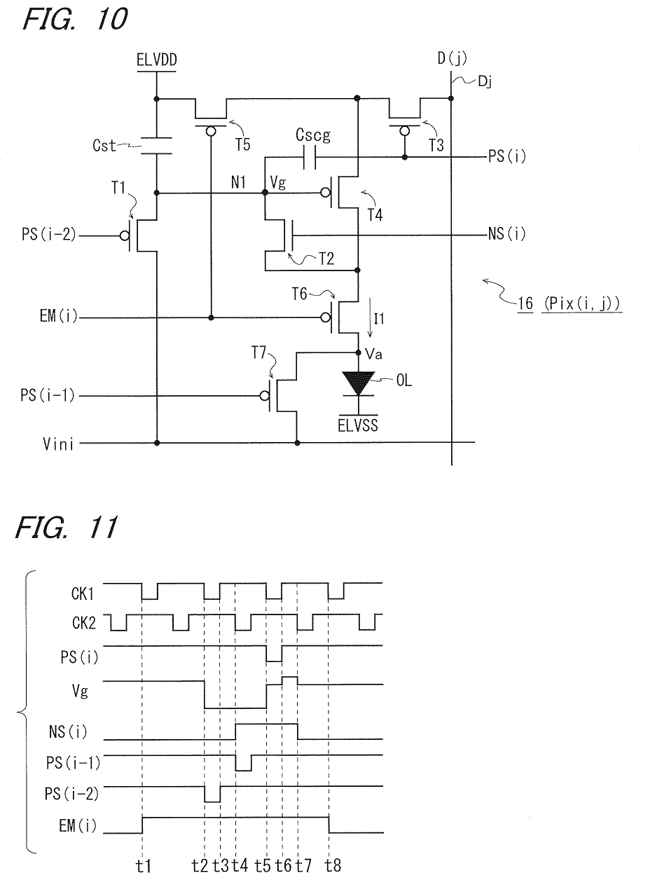

Next, an organic EL display device according to a second embodiment will be described with reference to FIGS. 10 and 11. FIG. 10 is a circuit diagram showing the configuration of the pixel circuit 16 in the present embodiment, and more specifically, the pixel circuit 16 corresponding to the ith first scanning signal line PSi and the jth data signal line Dj, i.e., the pixel circuit Pix(i,j) in the ith row and the jth column (1≤i≤n, 1≤j≤m). FIG. 11 is a signal waveform diagram for describing the operation of the pixel circuit 16 during the non-emission period included in each frame period. The display device according to the present embodiment is slightly different from the display device 10 according to the first embodiment in the configuration of the pixel circuit 16 and the drive signals for driving the pixel circuit 16, but is the same as the display device 10 according to the first embodiment above in other configurations. Therefore, in the following, portions of the configuration of the display device according to the present embodiment that are the same as or corresponding to those of the first embodiment (FIGS. 1 and 5) are denoted by the same reference numerals, and detailed description thereof is omitted.

As can be seen by comparing FIG. 10 with FIG. 5, in the pixel circuit 16 of the present embodiment, the first and second initialization transistors T1 and T7 are P-type transistors (more specifically, P-type LTPS-TFT), and in this respect, the pixel circuit 16 differs from the pixel circuit 15 of the first embodiment in which the first and second initialization transistors T1 and T7 are N-type transistors (more specifically, N-type IGZO-TFTs). In accordance with this difference, in the pixel circuit 16 of the present embodiment, as shown in FIG. 10, the gate terminal of the first initialization transistor T1 is connected to the first scanning signal line two lines prior to the corresponding first scanning signal line Psi (hereinafter also referred to as “preceding first scanning signal line”) PSi−2, and the gate terminal of the second initialization transistor T7 is connected to the first scanning signal line immediately preceding the corresponding first scanning signal line Psi (hereinafter also referred to as “immediately preceding first scanning signal line”). Other configurations in the pixel circuit 16 are similar to those of the pixel circuit 15 in the first embodiment above, and therefore, description thereof is omitted.

Next, the operation of the pixel circuit 16 shown in FIG. 10, i.e., the pixel circuit Pix(i, j) in the ith row and jth column in the present embodiment will be described with reference to FIGS. 10 and 11.

As can be seen by comparing FIG. 11 with FIG. 6 while taking into account that the first and second initialization transistors T1 and T7 are P-type transistors in the pixel circuit 16 of the present embodiment, within the non-emission period t1 to t8 during which the corresponding emission control signal EM(i) is at L level, the period t2 to t3 during which the preceding first scanning signal PS(i−2) which is the signal of the preceding first scanning signal line PSi−2 is at L level, is an initialization period, and the period t5 to t6 during which the corresponding first scanning signal PS(i) which is the signal of the corresponding first scanning signal line PSi is at L level, is a data write period. As a result of such operations during the initialization period t2 to t3 (initialization operation) and the data write period t5 to t6 (data write operation), the voltage of the node N1, i.e., the gate voltage Vg of the drive transistor becomes the initialization voltage Vini at time t2 and the data voltage Vdata+Vth with threshold compensation at time t5, as shown in FIG. 11 (see the previously mentioned equation (1)).

After that, as in the first embodiment above (see FIG. 6), at time t6, when the write control transistor T3 is turned off by the corresponding first scanning signal PS(i) changing from L level to H level, the gate voltage Vg of the drive transistor 14 rises from the voltage Vdata+Vth written during the data write period t5 to t6 by a voltage ΔVc corresponding to the capacitance value of the compensation capacitor Cscg. Furthermore, after that, when the corresponding second scanning signal NS(i) changes from H level to L level at time t7, the gate voltage Vg decreases by the pull-in voltage ΔVf in the present embodiment as in the comparative example and the first embodiment above. Considering the gate voltage increase of ΔVc at time t6 as well as the pull-in voltage ΔVf, the gate voltage Vg after time t7 is represented by the previously mentioned equation (2). Therefore, during the emission period after time t8, the current I1 corresponding to the voltage |Vgs| between the gate and source of drive transistor 14 based on the gate voltage Vg represented by the equation (2) flows through the drive transistor 14 and the organic EL element OL, and the organic EL element OL emits light with luminance corresponding to the current I1.

As described above, also in the present embodiment, as in the first embodiment, when the corresponding first scanning signal PS(i) changes from the L level to the H level to turn off the write control transistor T3, the gate voltage Vg of the drive transistor 14 increases by the voltage ΔVc corresponding to the capacitance value of the compensation capacitor Cscg. This voltage increase ΔVc can compensate for the pull-in voltage ΔVf generated when the corresponding second scanning signal NS(i) changes from H level to L level after the data write period t5 to t6. Therefore, in the present embodiment, as in the first embodiment, it is possible to prevent the defect of not reducing the luminance of the organic EL element OL to a sufficiently low value when black is to be displayed, i.e., a black display defect.

When implementing the pixel circuit 16 (FIG. 10) in the present embodiment, it is preferable to adopt the layout pattern shown in FIG. 8 for its characteristic portion, i.e., the circuit portion including the compensation capacitance Cscg and transistors T2, T3, T4 connected thereto, as in the first embodiment above. This prevents the increase in wiring capacitance of the data signal lines compared to the case where the layout pattern shown in FIG. 9 is adopted, so that the data signal line Dj can be driven at high speed and the area required for the layout of the threshold compensation transistor T2 can be reduced, thereby contributing to the reduction of the pixel circuit for higher resolution.

### 3. Modifications

The present invention is not limited to the above embodiments, and various modifications can be made without departing from the scope of the present invention.

For example, in each of the above embodiments, among the transistors in the pixel circuit 15 or 16, the P-type transistors are LTPS-TFTs and the N-type transistors are IGZO-TFTs, but the present invention is not limited to these. The present invention can be applied to any internal compensation type display device using a hybrid pixel circuit in which a P-type transistor and an N-type transistor are mixed. For example, an N-type LIPS-TFT may be used in the pixel circuit. However, in such a hybrid pixel circuit, in order to compensate for a decrease in the gate voltage Vg of the drive transistor due to the change in the control signal of the threshold compensation transistor T2 (corresponding second scanning signal NS(i) in the above pixel circuits 15, 16) for the purpose of preventing black display defects, it is a prerequisite that the conductivity types of the write control transistor T3 and the threshold compensation transistor T2 are different from each other in the pixel circuit.

As described above, in each of the above-described embodiments, the corresponding second scanning signal NS(i) is supplied to the gate terminal of the threshold compensation transistor T2, the corresponding first scanning signal PS(i) is supplied to the gate terminal of the write control transistor T3, and there is formed a compensation capacitance Cscg between the node N1 including the gate terminal of drive transistor T4 and the corresponding first scanning signal line PSi so that the decrease (pull-in voltage) ΔVf in the gate voltage Vg of the drive transistor 14 accompanying the change from H level to L level in the corresponding second scanning signal NS(i) is compensated for by the increase (compensation voltage) ΔVc in the gate voltage Vg accompanying the change from L level to H level in the corresponding first scanning signal PS(i). On the other hand, if there is used a signal other than the corresponding second scanning signal NS(i) that changes from H level to L level after the data writing period t5 to t6, that signal may cause a black display defect. Thus, if there is used a signal other than the corresponding second scanning signal NS(i) that may cause a black display defect, the above compensation capacitance Cscg should be formed so that the decrease in gate voltage Vg due to the change from H level to L level in that signal is also compensated for.

In the pixel circuit Pix(i,j) in the first embodiment, i.e., the pixel circuit 15, the preceding second scanning signal NSi−2 is connected to the gate terminal of the first initialization transistor T1 (see FIG. 5). In the pixel circuit Pix(i,j) in the second embodiment, i.e., the pixel circuit 16, the preceding first scanning signal line PSi−2 is connected to the gate terminal of the first initialization transistor T1 (see FIG. 10). However, the signal line to be connected to the gate terminal of the first initialization transistor T1 is not limited to these. Another signal line may be connected to the gate terminal of the first initialization transistor T1 if the another signal line controls the first initialization transistor T1 to ON state before the selection period of the corresponding first scanning signal line PSi and the selection period of the corresponding second scanning signal line NSi when the corresponding emission control line EMi is in the deactivated state. Furthermore, in the pixel circuit Pix(i, j) in the first embodiment, the immediately preceding second scanning signal NSi−1 is connected to the gate terminal of the second initialization transistor T7 (see FIG. 5), and in the pixel circuit Pix(i, j) in the second embodiment, the immediately preceding first signal line PSi−1 is connected to the gate terminal of the second initialization transistor T7 (see FIG. 10). However, the signal line to be connected to the gate terminal of the second initialization transistor T7 is not limited to these, but another signal line may be connected to the gate terminal of the second initialization transistor T7 if the another signal line controls the second initialization transistor T7 to ON state when the corresponding emission control line EMi is in the deactivated state. For example, in the pixel circuit Pix(i, j) in the first embodiment, the corresponding emission control line EMi may be connected to the gate terminal of the second initialization transistor T7.

While the embodiments have been described above taking as an example the organic EL display device, the present invention is not limited to the organic EL display device and can be applied to any internal compensation type display device using a hybrid pixel circuit as described above in which a current-driven display element is used. Examples of the display elements that can be used are organic EL elements, such as organic light-emitting diodes (OLEDs), inorganic light-emitting diodes, and quantum-dot light-emitting diodes (QLEDs).
10 Display device
11 Display portions
15, 16 Pixel circuit
Pix (j, i) Pixel circuit (i=1 to n, j=1 to m)
20 Display control circuit
30 Data-side drive circuit (data signal Line drive circuit)
40 Scanning-side drive circuit (scanning signal line drive circuit/emission control circuit)
Psi First scanning signal line (i=1, 2, . . . , n)
NSi Second scanning signal line (i=−1, 0, 1, . . . , n)
Dj Data signal line (j=1 to m)
Emi Emission control line (i=1 to n)
Vini Initialization voltage line, Initialization voltage
ELVDD High-level power supply line (First power supply line), High-level power supply voltage
ELVSS Low-level power supply line (Second power supply line), Low-level power supply voltage
OL Organic EL element (display element)
Cst Holding capacitor
Cscg Compensation capacitance
T1 First initializing transistor
T2 Threshold compensation transistor
T3 Write control transistor
T4 Drive transistor
T5 First emission control transistor
T6 Second emission control transistor
T7 Second initialization transistor

1. A pixel circuit provided in a display device with a display portion including a plurality of data signal lines, a plurality of first scanning signal lines, and a plurality of second scanning signal lines, the pixel circuit corresponding to one of the data signal lines, one of the first scanning signal lines, and one of the second scanning signal lines, comprising:
a current-driven display element;
a drive transistor having a control terminal, a first conduction terminal, and a second conduction terminal, and connected in series with the display element;
a holding capacitor whose first electrode is connected to the control terminal of the drive transistor so as to hold a voltage of the control terminal of the drive transistor;
a write control transistor as a switching element having a control terminal connected to a corresponding one of the first scanning signal lines, a first conduction terminal connected to a corresponding one of the data signal lines, a second conduction terminal connected to the first conduction terminal of the drive transistor; and
a threshold compensation transistor as a switching element having a control terminal connected to a corresponding one of the second scanning signal lines, a first conduction terminal connected to the second conduction terminal of the drive transistor, a second conduction terminal connected to the control terminal of the drive transistor, wherein,
the write control transistor and the threshold compensation transistor have different conductivity types from each other, and
there is formed a capacitance between the corresponding one of the first scanning signal lines and the control terminal of the drive transistor.

2. The pixel circuit according to claim 1, wherein,
the corresponding one of the first scanning signal lines and the corresponding one of the second scanning signal lines have respective wiring patterns adjacent to each other and arranged such that the wiring pattern of the corresponding one of the first scanning signal lines is farther from the drive transistor than the wiring pattern of the corresponding one of the second scanning signal lines, and
the capacitor is formed by arranging a wiring pattern connecting the control terminal of the drive transistor and the second conduction terminal of the threshold compensation transistor so as to partially overlap with the wiring pattern of the first scanning signal line connected to the control terminal of the write control transistor.

3. The pixel circuit according to claim 1 or 2, wherein,
the drive transistor and the write control transistor are thin-film transistors whose channel layers are formed of low-temperature polysilicon, and
the threshold compensation transistor is a thin-film transistor whose channel layer is formed of oxide semiconductor.

4. The pixel circuit according to claim 3, further comprising first and second emission control transistors as switching elements, wherein,
the display portion further includes first and second power supply lines as well as a plurality of emission control lines,
the pixel circuit corresponds to one of the emission control lines,
the first and second emission control transistors have respective control terminals both connected to a corresponding one of the emission control lines,
the drive transistor as well as the first and second emission control transistors are all thin film transistors whose channels are formed of low-temperature polysilicon,
the first conduction terminal of the drive transistor is connected to the first power supply line via the first emission control transistor,
the second conduction terminal of the drive transistor is connected to a first electrode of the display element via the second emission control transistor,
the display element is connected at a second electrode to the second power supply line, and
the holding capacitor is connected at a second electrode to the first power supply line.

5. The pixel circuit according to claim 1, wherein,
the drive transistor and the write control transistor are P-type thin-film transistors, and
the threshold compensation transistor is an N-type thin-film transistor.

6. The pixel circuit according to claim 5, wherein,
the P-type transistors are all thin-film transistors whose channel layers are formed of low-temperature polysilicon, and
the N-type transistor is a thin-film transistor whose channel layer is formed of oxide semiconductor.

7. A display device with a display portion including a plurality of data signal lines, a plurality of first scanning signal lines, and a plurality of second scanning signal lines, comprising:
a plurality of the pixel circuits according to claim 1 each of which corresponds to one of the data signal lines, one of the first scanning signal lines, and one of the second scanning signal lines;
a data signal line drive circuit configured to drive the data signal lines; and
a scanning signal line drive circuit configured to selectively drive the first scanning signal lines and selectively drive the second scanning signal lines.

8. A display device with a display portion including a plurality of data signal lines, a plurality of first scanning signal lines, a plurality of second scanning signal lines, and a plurality of emission control lines, comprising:
a plurality of the pixel circuits according to claim 4 each of which corresponds to one of the data signal lines, one of the first scanning signal lines, one of the second scanning signal lines, and one of the emission control lines;
a data signal line drive circuit configured to drive the data signal lines;
a scanning signal line drive circuit configured to drive the first scanning signal lines so as to be sequentially selected and drive the second scanning signal lines so as to be sequentially selected; and
an emission control circuit configured to selectively drive the emission control lines such that during a predetermined period that includes a selection period of the corresponding one of the first scanning signal lines and a selection period of the corresponding one of the second scanning signal lines, the corresponding one of the emission control lines is in a deactivated state.
